(19) United States
(12) Patent Application Publication
(10) Pub. No.: US 2026/0195748 A1
(43) Pub. Date: Jul. 9, 2026

(54) PAYMENT CHANNEL AGGREGATOR

(71) Applicant: nChain Licensing AG, Zug (CH)

(72) Inventors: Daniel JOSEPH, London (GB); Craig Steven WRIGHT, London (GB)

(21) Appl. No.: 19/131,899

(22) PCT Filed: Nov. 2, 2023
(86) PCT No.: PCT/EP2023/080549

§ 371 Date: May 21, 2025

(30) Foreign Application Priority Data
Nov. 23, 2022 (GB) 2217487.4

(51) Int. Cl. G06Q 20/40; G06Q 20/02; G06Q 20/38

(52) U.S. Cl. CPC G06Q 20/401; G06Q 20/02; G06Q 20/3825

(57) ABSTRACT

A computer-implemented method of facilitating payments between multiple first parties and a second party, comprising: executing a respective payment channel between each respective first party and an intermediate party by: obtaining a channel opening transaction comprising an output locking a maximum value; obtaining one or more channel closing transactions including a final channel closing transaction, the final channel closing transaction comprising a first output and a second output, the first output locking a first amount of the maximum value, and second output locking a second amount of the maximum value; and generating a payment transaction, wherein the payment transaction comprises a plurality of inputs, each input referencing a second output of a final channel closing transaction, and an output locked to a public key of the second party, the output locking a value based on a total of the second amounts locked by the second outputs.

### CROSS REFERENCE TO RELATED APPLICATIONS

This application is the U.S. National Stage of International Application No. PCT/EP2023/080549 filed on Nov. 2, 2023, which claims the benefit of United Kingdom Patent Application No. GB2217487.4, filed on Nov. 23, 2022, the contents of which are all incorporated herein by reference in their entireties.

### TECHNICAL FIELD

The present disclosure relates to methods of facilitating a plurality of respective payments between a plurality of respective first parties and a second party.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

In a blockchain context, a payment channel is a set of transactions between two parties (where each transaction represents at least one payment) and a corresponding protocol for signing and submitting transactions that allows for a set of valid and secure payments to be made between two parties without committing the entire set of transactions to the blockchain. Of the set of transactions of the payment channel, only two transactions are submitted to the blockchain, regardless of the number of transactions created. One of these submitted transactions is representative of the final agreed-upon payment at the end of an iterative negotiation, or it could be the summation of a set of periodic payments.

For the latter, one may consider the example of a one-year subscription (e.g. to a streaming platform such as Netflix) comprising twelve monthly payments. For each month, a copy of a valid and secure transaction is given to the streaming platform by the customer. The streaming platform can submit the transaction to the blockchain if they so desire. Each month's transaction contains a payment that is the accumulation of the amounts owed for the current and previous months. However, the streaming platform only submits the final transaction to the blockchain. This transaction contains the accumulated payments for the entire twelve months.

Usually, the expectation is that the payment channel is established between the two parties, the payer (e.g. Alice), and the intended recipient of the payment (e.g. Bob), where Bob would be the provider of goods/services. However, as recognised herein, in some circumstances, an intermediary may be desired.

According to one aspect disclosed herein, there is provided a computer-implemented method of facilitating a plurality of respective payments between a plurality of respective first parties and a second party, wherein the method is performed by an intermediate party and comprises:
executing a respective payment channel between each respective first party and the intermediate party, wherein executing the respective payment channel comprises:
   obtaining a respective channel opening transaction, the respective channel opening transaction comprises a respective input signed by the respective first party, and a respective output locked to a respective public key of the respective first party and a public key of the intermediate party, wherein the respective output locks a respective maximum value;
   obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value; and
generating a payment transaction, wherein the payment transaction comprises a plurality of respective inputs, each respective input references a respective second output of a respective final channel closing transaction and comprising a signature of the intermediate party, and an output locked to a public key of the second party, wherein the output locks a value based on a total of the respective second amounts locked by the respective second outputs.

In this aspect, an intermediary is used to facilitate payments between multiple payers and a payee. The intermediary establishes a payment channel with each payer. Upon each payment channel being closed (i.e. settled), the intermediary submits a payment transaction to the blockchain which transfers an amount to the payee based on the outcome of each separate payment channel.

This intermediary (e.g. Ivan) receives payments from the multiple payers (e.g. multiple instances of Alice) on behalf of the payee (e.g. Bob), then makes a payment to Bob. As an example, a streaming platform may outsource collection of its subscription fees to a third-party collection agency. This agency collects all subscription fees then pays the accumulated fees to the platform in one or more payments. This is a more efficient process than each user having to engage separately with the streaming platform.

According to another aspect disclosed herein, there is provided a computer-implemented method of facilitating a plurality of respective payments between a plurality of respective first parties and a second party, wherein the method is performed by an intermediate party and comprises:
obtaining a funding transaction generated by the second party, wherein the funding transaction comprises an input comprising a signature of the second party, and an output locked to a public key of the intermediate party, wherein the output locks an amount at least equal to a total of a plurality of respective maximum values; and
executing a respective payment channel between each respective first party and the intermediate party, wherein executing the respective payment channel comprises:
   obtaining a respective channel opening transaction, the respective channel opening transaction comprises a respective input signed by the intermediate party, and a respective output locked to a respective public key of the respective first party and a public key of the intermediate party, wherein the respective output locks a respective maximum value;
   obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value.

In this aspect, an intermediary is used to facilitate payments between a payer and multiple payees. The intermediary receives funding transaction from the payer which sends an amount to the intermediary. The intermediary then establishes a payment channel with each payee. The intermediary closes (i.e. settles) the payment channels with each payee, e.g. after an agreed-upon amount of payments, after an agreed-upon amount of time, in response to a request from the payer, etc.

In this scenario, a party (e.g. Alice) may subscribe to multiple services (e.g. multiple instances of Bob), in which case it is more convenient (and efficient) to have an intermediary disperse these payments to the various services on his/her behalf.

In both aspects, the use of an intermediary increases the privacy of the parties (payer(s) and payee(s)) as, from an outside perspective, a third party cannot determine both the source and destination of the payments, since either the source or destination is replaced by the intermediary.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 illustrates an example of a one-to-one payment channel,

FIG. 4 illustrates an example of a many-to-one payment channel, and

FIG. 5 illustrates an example of a one-to-many payment channel.

### DETAILED DESCRIPTION OF EMBODIMENTS

### 1. Example System Overview

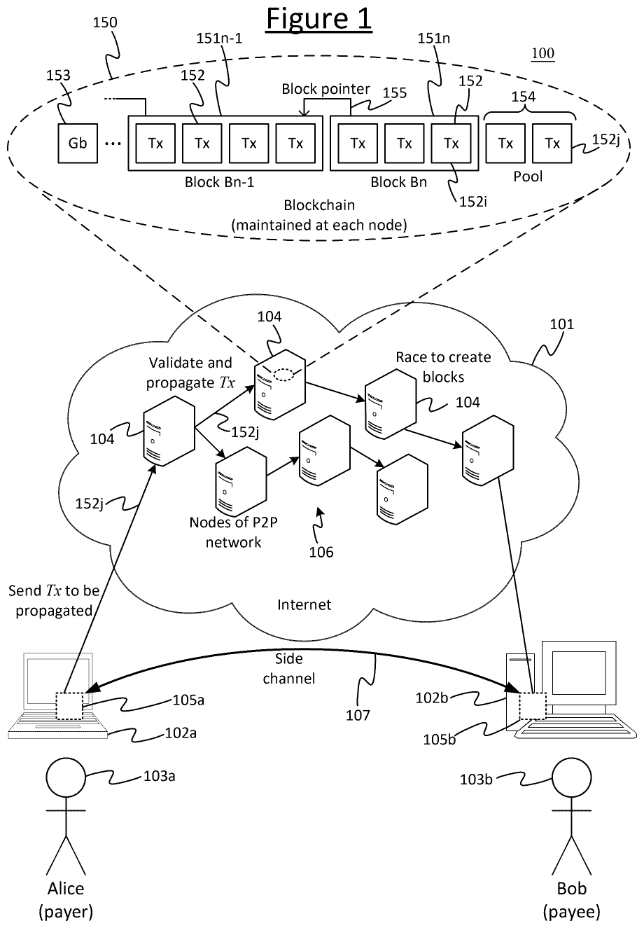

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

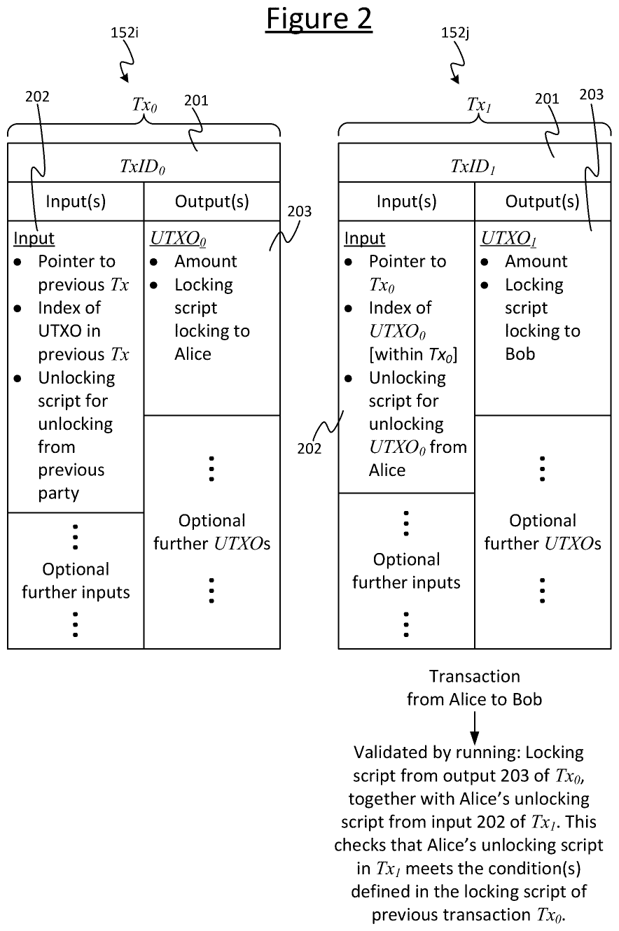

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀′ in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}> <P_{A}>∥[Checksig P_{A}]
where “|” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Payment Channels

In a typical payment channel implementation, a nearly unlimited number of payments can be made but it is only ever necessary to add two transactions to the blockchain 150. In addition to the reduced number of transactions being added to the blockchain and the associated reduced costs, storage and bandwidth usage, payment channels also offer the advantage of speed and the ability of the payers to have their funds refunded if things do not go as planned or either party decides not to proceed beyond a certain set of payments. A description of a payment channel implementation is outlined below.

First Note that

“For each bitcoin transaction, you can have more than one input. For each input, there is a parameter called the sequence number. This number is an indication of whether the transaction that includes this input is finalised or not. If the parameter does not take the maximum value (0xFFFFFFFF), then the validation process will look at the locktime field (defined at the transaction level), which specifies a time when the transaction becomes valid, i.e. a transaction is not valid until the locktime. This can be useful when the time specified is in the future. (The furthest you can choose for locktime is roughly 9,500 years in the future, at the time of writing.) Before the locktime of a given transaction matures, a new version of that transaction, with a larger sequence number, can invalidate the earlier version that spends the same input but with a smaller sequence number.” [nchain.com/payment-channels-and-smart-contracts-on-bitcoin/]

Now consider the scenario where Alice 103a needs to pay Bob 103b for a service where this may require multiple payments from Alice 103a to Bob 103b over a period of time, as the situation demands. Alice 103a expects to spend at most 15 BSV (in total) to Bob 103b in the possible set of exchanges. To facilitate this a payment channel is established between Alice 103a and Bob 103b and operates as follows.

Alice creates a 2-of-2 multi-signature transaction, T_{c} that commits 15 BSV originating from Alice 103a. A multi-signature locking script requires that two individuals (Alice and Bob) sign any transaction that spends the corresponding locked output. At this point the transaction is not submitted to blockchain network 106.

TABLE 1
Funding transaction T_{c}
T_{c}

| Version | 1 | | nLockTime | 0 |
|---|---|---|---|---|
| In-count | 1 | | Out-count | 2 |
| Input List | | | Output list | |
| | Unlocking | Sequence | | Locking |
| Outpoint | script | no. | Value | Script |
| Alice's input | [symbol] Sig_{A} [symbol] [symbol] P_{A} [symbol] | 0xffffffff | 15 BSV | [2-2 multisig |
| | | | | Alice Bob] |

Alice 103a creates a separate refund transaction, T_{r,0}, returning all the funds from the ‘multi-signature controlled funds’ to Alice 103a. This transaction includes an nLockTime value of sᵣ_{₀}. nLockTime is a blockchain transaction parameter that allows a blockchain transaction to only be executable after a specified time has passed. Bob 103a signs the blockchain transaction. This refund transaction allows Alice 103a to be refunded, after nLockTime has transpired, if the exchange between Alice 103a and Bob 103b goes awry.

TABLE 2
Refund transaction T_{r, 0}
T_{r, 0}

| Version | 1 | | nLockTime | sᵣ_{₀} |
|---|---|---|---|---|
| In-count | 1 | | Out-count | 2 |
| Input List | | | Output list | |
| | Unlocking | Sequence | | Locking |
| Outpoint | script | no. | Value | Script |
| T_{c} \|\| 0 | [symbol] Sig_{A} [symbol] [symbol] P_{A} [symbol] [symbol] Sig_{B} [symbol] [symbol] P_{B} [symbol] | 0x00000001 | 15 BSV | [P2PKH Alice] |

Alice 103a signs the original transaction Tc. At this point Alice 103a and Bob 103b may proceed to create new refund transactions to reflect the (off-chain) payments being made from Alice 103a to Bob 103b. These refund transactions would reflect the net sum of money that Alice 103a is required to pay Bob 103b at that point in time. As an example, if Alice 103a is to pay Bob 103b 5 BSV, a new refund transaction, T_{r,i}, is created that has outputs sending 5 BSV to Bob 103b and 10 BSV back to Alice 103a. If Alice 103a needs to pay another 5 BSV to Bob 103b then the new refund transaction, T_{r,i+1}, is created with outputs sending 10 BSV to Bob 103b and 5 BSV to Alice 103a. For each new refund transaction, assuming agreement with the details, both parties sign the transaction but do not necessarily submit the transaction to the network 106.

TABLE 3
Refund transaction T_{r, 1}
T_{r, 1}

| Version | 1 | | nLockTime | sᵣ_{₁} |
|---|---|---|---|---|
| In-count | 1 | | Out-count | 2 |
| Input List | | | Output list | |
| | Unlocking | Sequence | | Locking |
| Outpoint | script | no. | Value | Script |
| T_{c} \|\| 0 | [symbol] Sig_{A} [symbol] [symbol] P_{A} [symbol] [symbol] Sig_{B} [symbol] [symbol] P_{B} [symbol] | 0x00000002 | 10 BSV | [P2PKH Alice] |
| | | | 5 BSV | [P2PKH Bob] |

TABLE 4
Refund transaction T_{r, 2}
T_{r, 2}

| Version | 1 | | nLockTime | sᵣ_{₂} |
|---|---|---|---|---|
| In-count | 1 | | Out-count | 2 |
| Input List | | | Output list | |
| | Unlocking | Sequence | | Locking |
| Outpoint | script | no. | Value | Script |
| T_{c} \|\| 0 | [symbol] Sig_{A} [symbol] [symbol] P_{A} [symbol] [symbol] Sig_{B} [symbol] [symbol] P_{B} [symbol] | 0x00000003 | 5 BSV | [P2PKH Alice] |
| | | | 10 BSV | [P2PKH Bob] |

Note that each successive refund transaction created has a lower nLockTime than that of the previous refund transaction and a higher sequence number:

S_{r,i+1}<S_{r,i}

If a party refuses to sign any T_{r,i} then the aggrieved party may simply submit the T_{r,i-1}. In the worst-case scenario, Alice 103a signs T_{r,0} and submits it to the network 106 reclaiming all her funds (after nLockTime has expired). The final refund transaction constructed represents the net sum of funds being transferred from Alice 103a to Bob 103b. This transaction is submitted to the network 106. The refund transaction that is submitted to the blockchain network 106 is referred to herein as the settlement transaction.

### 6. Facilitating Blockchain Payments

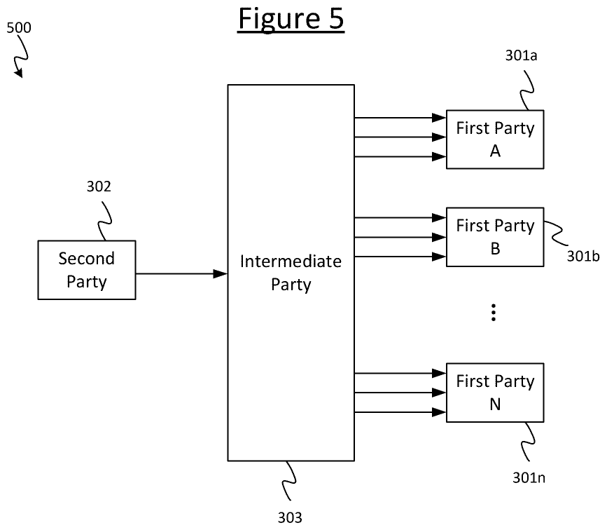

Embodiments of the present disclosure provide an intermediary 303 for facilitating payments between multiple first parties 301 and a second party 302. In some embodiments, as shown in FIG. 4, the multiple first parties 301 are considered as payers and the second party 302 is considered as a payee. In other embodiments, as shown in FIG. 5, the second party 302 is considered as the payer and the multiple first parties 301 and considered as payees.

FIG. 4 illustrates an example system 400 in which an intermediary 303 establishes multiple payment channels, one per first party 301, and forwards a payment to a second party 302. Each first party 301, the intermediary 303, and the second party may be configured to perform any of the actions described above as being performed by Alice 103a and/or Bob 103b with reference to FIGS. 1 and 2. The system 400 may comprise any number n of first parties 301. In these embodiments, the second party 302 may supply, to each first party 301, respective goods and/or services in return for payment.

The intermediary 303 establishes a respective payment channel with each first party 301, i.e. one per first party 301. Establishing a respective payment channel comprises obtaining a respective channel opening transaction. A channel opening transaction may also be referred to as an initial transaction, or a funding transaction. Each respective channel opening transaction comprises an input signed by the respective first party 301. That is, the input references an output of a previous transaction, where that output is controlled by (i.e. locked to) a public key owned by the respective first party 301. Each respective channel opening transaction comprises an output locked to a public key of the respective first party 301 and a public key of the intermediary 303 (e.g. the output may be a multi-signature output). Unless the context requires otherwise, each reference herein to a party's public key may mean the same public key or a different public key owned by that party. For example, each channel opening transaction may have an output locked to the same public key of the intermediary 303. The output of each respective channel opening transaction locks a respective maximum value, i.e. an amount of underlying digital asset (e.g. Satoshis) of the blockchain 150.

The intermediary 303 may generate one, some or all of the respective channel opening transactions. The intermediary 303 may receive one, some or all of the respective channel opening transactions from the respective first parties 301.

The intermediary 303 and each respective first party 301 execute the respective payment channels. This involves, for each respective payment channel, obtaining one or more respective channel closing transactions. A channel closing transaction may also be referred to as a final transaction or a refund transaction. For each payment channel, each of the one or more respective channel closing transactions comprises a respective input that references the output of the respective channel opening transaction used to open that payment channel. The input may be signed by the intermediary 303 and/or the respective first party 301. Each of the one or more respective payment channel closing transactions comprises a respective output locked to a public key of the respective first party 301, and a respective output locked a public key of the intermediary 303. The output locked to the public key of the first party locks a first amount of the respective maximum value locked by the output of the respective channel opening transaction. Similarly, the output locked to the public key of the intermediary locks a second amount of the respective maximum value locked by the output of the respective channel opening transaction. Together, the first and second amounts are at most equal to the maximum value. As discussed below, the first and second amounts may be less that the maximum value.

For each respective payment channel, the intermediary 303 uses one of the respective channel closing transactions to close the payment channel by causing that closing channel transaction to be submitted to the blockchain network 106. The transaction used to close the payment channel is referred to as the final channel closing transaction. The intermediary 303 may submit the final channel closing transaction to the blockchain network 106, or the second party 302 may submit the final channel closing transaction to the blockchain network 106.

Once each payment channel is closed, by the respective final channel closing transaction being submitted to the blockchain network 106, the intermediary 303 generates a payment transaction. The payment transaction comprises a respective input that references, for each respective final channel closing transaction, the respective output of that respective final channel closing transaction that is locked to the public key of the intermediary 303. Each respective input is signed by the intermediary 303. The payment channel transaction includes an output locked to a public key controlled by the second party 302.

The payment transaction may include metadata relating to one, some or all of the payments, e.g. an identifier of the respective first party, a payment reference, etc. The channel opening and/or channel closing transactions may also comprise metadata relating to the respective payment of the respective payment channel.

In some examples, the intermediary 303 may deduct a service charge for facilitating the payments. An example of which is shown in below in Tables 8, 9 and 10, which show examples of a channel opening transaction, a channel closing transaction, and a payment transaction, respectively.

FIG. 5 illustrates an example system 500 in which an intermediary 303 establishes multiple payment channels, one per first party 301 in order to make payments to each first party 301 on behalf of a second party 302. Each first party 301, the intermediary 303, and the second party may be configured to perform any of the actions described above as being performed by Alice 103a and/or Bob 103b with reference to FIGS. 1 and 2. The system 500 may comprise any number n of first parties 301. In these embodiments, each first party 301 may supply to the second party 302, respective goods and/or services in return for payment.

The intermediary 303 obtains a funding transaction which has been generated by the second party 302. The funding transaction includes an input signed by the second party 302 and output locked to a public key controlled by the intermediary 303. The output locks a total amount equal to at least a plurality of respective maximum values, each maximum value being associated with a maximum payment to a respective first party 301. The total amount may include a service charge for collection by the intermediary 303. The intermediary 303 may obtain the funding transaction from the blockchain 150, or from the second party 302.

The intermediary 303 establishes a respective payment channel with each first party 301, i.e. one per first party 301. In these embodiments, establishing a respective payment channel comprises obtaining (e.g. generating) a respective channel opening transaction. Each respective channel opening transaction comprises an input signed by the intermediary party 303. That is, the input references an output of a previous transaction, where that output is controlled by (i.e. locked to) a public key owned by the intermediary party 303. Each respective channel opening transaction comprises an output locked to a public key of the respective first party 301 and a public key of the intermediary 303 (e.g. the output may be a multi-signature output). The output of each respective channel opening transaction locks a respective maximum value, i.e. an amount of underlying digital asset (e.g. Satoshis) of the blockchain 150.

The intermediary 303 and each respective first party 301 execute the respective payment channels. This involves, for each respective payment channel, obtaining one or more respective channel closing transactions. For each payment channel, each of the one or more respective channel closing transactions comprises a respective input that references the output of the respective channel opening transaction used to open that payment channel. The input may be signed by the intermediary 303 and/or the respective first party 301. Each of the one or more respective payment channel closing transactions comprises a respective output locked to a public key of the respective first party 301, and a respective output locked a public key of the intermediary 303. The output locked to the public key of the first party locks a first amount of the respective maximum value locked by the output of the respective channel opening transaction. Similarly, the output locked to the public key of the intermediary locks a second amount of the respective maximum value locked by the output of the respective channel opening transaction. Together, the first and second amounts are at most equal to the respective maximum value. As discussed below, the first and second amounts may be less that the maximum value.

For each respective payment channel, the intermediary 303 uses one of the respective channel closing transactions to close the payment channel by causing that closing channel transaction to be submitted to the blockchain network 106. The transaction used to close the payment channel is referred to as the final channel closing transaction. The intermediary 303 may submit the final channel closing transaction to the blockchain network 106, or the respective first party 302 may submit the final channel closing transaction to the blockchain network 106.

The funding transaction may include metadata relating to one, some or all of the payments, e.g. an identifier of the respective first party, a payment reference, etc. The channel opening and/or channel closing transactions may also comprise metadata relating to the respective payment of the respective payment channel.

Tables 11, 12 and 13 below illustrate examples of a funding transaction, channel opening transaction and channel closing transaction, respectively.

It will be appreciated that terms used herein such as “funding”, “payment”, “channel opening”, “channel closing”, etc. are merely used as labels for particular transactions.

### 7. Example Payment Channel Aggregator

This section describes an example payment channel aggregator (PCA) according to embodiments of the present disclosure, a system that facilitates the inclusion of an intermediary (I-Ivan) between a pair of parties (A-Alice and B-Bob) who would have previously used a payment channel directly between themselves (Alice and Bob).

### 7.1 One to One

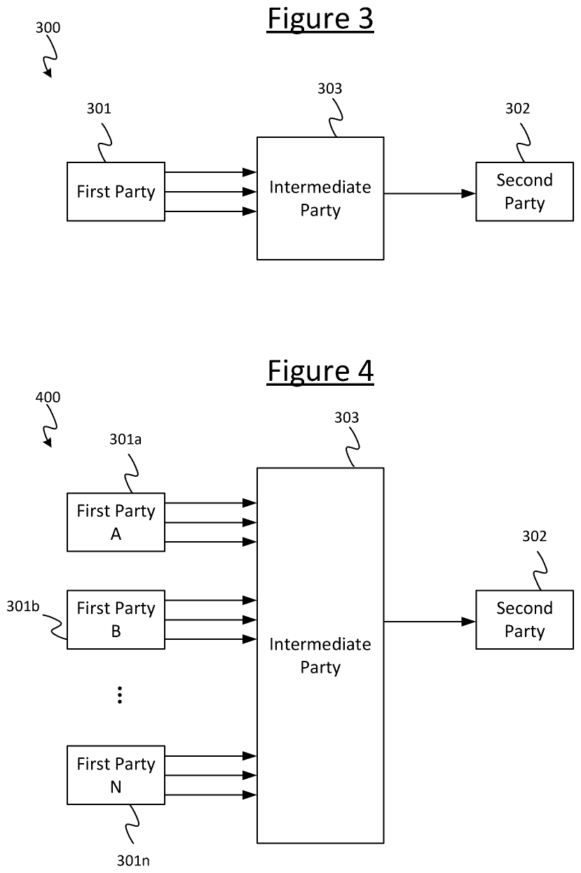

FIG. 3 illustrates an example system 300 for facilitating payments between a first party 301 and a second party 302 using an intermediate party 303. For convenience, the first party 303 will be referred to as Alice 103a, the second party as Bob 103b and the intermediate party as Ivan 303. For one-to-one payments it is assumed that a party Alice 103a is to pay intermittent payments to Bob 103b for services or goods. This would have previously been carried out via a payment channel between both parties. However, in the PCA for said scenario, an intermediary (Ivan) 303 is utilised to handle the payments from Alice 103a to Bob 103b.

### The PCA Involves the Following Steps:

Ivan 303, Alice 103a, and Bob 103b come to an agreement that Ivan 303 will collect payments from Alice 103a and then Ivan 303 would subsequently transfer these funds to Bob 103b (possibly by a specified deadline).
Alice 103a and Ivan 303 create a payment channel between themselves, that would be utilised to facilitate intermittent payments to Ivan 303. This includes the creation of a funding transaction that may refund to Alice 103a (or pay to Ivan 303) a maximum amount, Max BSV.
At the conclusion of Alice's payments ‘the payment channel is closed’ (i.e. the settlement transaction is submitted to the blockchain 150).
Ivan 303 transfers the value of the settlement transaction, x_{f}, to Bob 103b. (Ivan 303 may deduct a previously-agreed-upon personal service charge sc before paying x_{f} to Bob 103b). Note that, rather than being a flat fee, this service charge may be proportional to the amount that Ivan has been able to collect from Alice 103a (on behalf of Bob 103b). This is in that the service charge scᵢ₊₁ for refund transaction T_{r,i+1} would be greater than the service charge sc; for refund transaction T_{r,i}.
To prevent the increased service charge from reducing the payment to Bob 103b, an additional input may be added to the refund transaction that has the responsibility of funding the service charges.

For the payment channel utilised, an example of the funding transaction Tc and one of the refund transactions Tri are shown in Table 5 and Table 6 respectively. OP_RETURN outputs may be included in both transactions to store metadata related to agreements between Alice 103a, Bob 103b, and Ivan 303. This metadata may include data related to the transaction. E.g., If a Netflix subscription, the metadata may include a hash of a licensing agreement, a subscription ID, a start date, an end data, and a specific tier of service requested, etc.

TABLE 5
Funding Transaction PCA One-to-One
T_{c}

| Version | 1 | | nLockTime | 0 |
|---|---|---|---|---|
| In-count | 1 | | Out-count | 2 |
| Input List | | | Output list | |
| | Unlocking | Sequence | | Locking |
| Outpoint | script | no. | Value | Script |
| Alice's input | [symbol] Sig_{A} [symbol] [symbol] P_{A} [symbol] | 0xffffffff | Max | [2-2 multisig Alice |
| | | | | Ivan] |
| | | | | OP_FALSE |
| | | | | OP_RETURN Meta |

TABLE 6
Refund Transaction. PCA One-to-One
T_{r, i}

| Version | 1 | | nLockTime | sᵣ_{ᵢ} |
|---|---|---|---|---|
| In-count | 1 | | Out-count | 3 |
| Input List | | | Output list | |
| | Unlocking | Sequence | | Locking |
| Outpoint | script | no. | Value | Script |
| T_{c} \|\| 0 | [symbol] Sig_{A} [symbol] [symbol] P_{A} [symbol] [symbol] Sig_{I} [symbol] [symbol] P_{I} [symbol] | i | Max − (xᵢ + scᵢ) | [P2PKH Alice] |
| | | | xᵢ + scᵢ | [P2PKH Ivan] |
| | | | 0 | OP_FALSE |
| | | | | OP_RETURN |
| | | | | Meta |

When Ivan 303 is to pay Bob 103b, this may be done using a P2PKH transaction (T_{payment}) as shown in Table 7. This transaction spends Ivan's UTXO of the settlement T_{r,k} transaction. Metadata may be included in the payment transaction that would link the payment to Alice's subscription. This may include the previously mentioned metadata like subscription ID plus additional information like final iteration signed (e.g., paid till June 2022), hash of the settlement refund transaction, etc.

TABLE 7
Payment from Ivan to Bob for all funds received up to iteration k
T_{Payment}

| Version | 1 | | nLockTime | 0 |
|---|---|---|---|---|
| In-count | 1 | | Out-count | 2 |
| Input List | | | Output list | |
| | Unlocking | Sequence | | Locking |
| Outpoint | script | no. | Value | Script |
| T_{r, f} \|\| 1 | [symbol] Sig_{I} [symbol] [symbol] P_{I} [symbol] | 0xffffffff | Max − (x_{f} + | [P2PKH Bob] |
| | | | sc_{f}) | |
| | | | 0 | OP_FALSE |
| | | | | OP_RETURN |
| | | | | Meta |

### 7.2 Many to One

FIG. 4 illustrates an example system 400 for facilitating payments between multiple first parties 301a, 301b, . . . 301n, and a second party 302 using an intermediate party 303. For convenience, each first party 303 will be referred to as Alice 103a, the second party as Bob 103b and the intermediate party as Ivan 303. For many-to-one it is assumed that there are multiple Alices {Alice; |j∈[1, n]} who are to pay intermittent payments to Bob 103b for services or goods. (e.g. multiple subscribers needing to pay monthly payments to Netflix).

This would have previously been carried out, for each subscriber Aliceⱼ, via their individual respective payment channel between each Alice and Bob (e.g. Netflix).

However, using the PCA, an intermediary, Ivan 303, is utilised to manage these payments.

This intermediary 303 will accept the iterative payments for each channel then eventually the settlement transaction is submitted to the blockchain 150. The combined value of these n settlement transactions are then forwarded, by Ivan 303, to Bob 103b.

### The Following Steps are Performed:

Each Alice; comes to their agreement with Bob 103b and Ivan 303; this is an agreement that Ivan 303 will collect payments from Alice; and then Ivan 303 would subsequently transfer the value of the respective settlement transactions to Bob 103b (possibly by a specified deadline).
Aliceⱼ and Ivan 303 create a payment channel between themselves; these would be utilised as a regular payment channel, to facilitate intermittent payments to Ivan 303.
At the conclusion of Alice's payments ‘the payment channel is closed’.
After the n channels are closed, Ivan 303 transfers the combined value of the n settlement transactions

$${\sum }_{j}^{n} {x}_{f}^{j} ,$$

to Bob 103b. This may be in the form of one or more payment transactions.

Assuming a single final payment to Bob 103b from Ivan 303 (transaction example shown in Table 8) and an agreed-upon deadline, s_{close}, for Ivan's payment to Bob 103b, this requires that the latest nLockTime value for any of the n payment channels be less than s_{close}. Note that the “latest locktime” of payment channel is the nLockTime of the first iteration of a refund transaction of the channel as S_{r,i+1}<S_{r,i}. As such the latest locktime of the n payment channels would be a first iteration refund transactions of these channels that has the latest time.

For the payment channel utilised for an Alice, and Ivan 303 an example of the funding transaction

$${T}_{c , i}^{j}$$

and one of the refund transactions

$${T}_{r , i}^{j}$$

is shown below in Tables 9 and 10.

TABLE 8
Funding Transaction PCA. Many-to-One. Trusted
${T}_{c}^{j}$

| Version | 1 | nLockTime | 0 | |
|---|---|---|---|---|
| In-count | 1 | Out-count | 2 | |
| Input List | | Output list | | |
| | Unlocking | | | |
| Outpoint | script | Seq. no. | Value | Locking Script |
| Alice's | [symbol] Sig_{A}_{ⱼ} [symbol] [symbol] P_{A}_{ⱼ} [symbol] | 0xffffffff | Maxⱼ BSV | [2-2 multisig |
| input | | | | Aliceⱼ Ivan] |

OP_FALSE
OP_RETURN Meta

TABLE 9
Refund Transaction. PCA. Many-to-One. Trusted
${T}_{r , i}^{j}$

| Version | 1 | | nLockTime | Sᵣ_{_{k,i}} |
|---|---|---|---|---|
| In-count | 1 | | Out-count | 2 |
| Input List | | | Output list | |
| | | Seq. | | |
| Outpoint | Unlocking script | no. | Value | Locking Script |
| T_{c} \|\| 0 | [symbol] Sig_{A}_{ⱼ} [symbol] [symbol] P_{A}_{ⱼ} [symbol] | i | $Max - ( {x}_{i}^{j} + s {c}_{i}^{j} )$ | [P2PKH Aliceⱼ] |
| | [symbol] Sig_{I} [symbol] [symbol] P_{I} [symbol] | | ${x}_{i}^{j} + s {c}_{i}^{j}$ | [P2PKH Ivan] |
| | | | | OP_FALSE |
| | | | | OP_RETURN |
| | | | | Meta |

After all the settlement transactions for all the payment channels have been received by Ivan 303, he can then proceed to pay the combined sums to Bob (e.g. Netflix). He makes this payment by spending the appropriate UTXOs of the settlement refund transactions. An example of this payment to Bob from Ivan is shown in Table 10. The metadata in this transaction may include details that link the payment to the settlement refund transactions between the Alice's and Ivan 303. More specifically it may include the hash of the settlement transactions as well as the details of the individual ‘subscriptions’.

TABKE 10
Payment from Ivan to Bob for all funds from all Aliceⱼs
after their settlements.
T_{Payment}

| Version | 1 | | nLockTime | 0 |
|---|---|---|---|---|
| In-count | n | | Out-count | 2 |
| Input List | | | Output list | |
| | Un- | Se- | | |
| | locking | quence | | |
| Outpoint | script | no. | Value | Locking Script |
| ${T}_{r , f}^{1} \vert \vert 1$ | [symbol] Sig_{I} [symbol] [symbol] P_{I} [symbol] | 0×ffffffff | ${\sum }_{j = 1}^{n} ( {Max}_{j} - ( {x}_{f}^{j} + s {c}_{f}^{j} ) )$ | [P2PKH Bob] |
| ${T}_{r , f}^{2} \vert \vert 1$ | [symbol] Sig_{I} [symbol] | | 0 | OP_FALSE |
| | [symbol] P_{I} [symbol] | | | OP_RETURN |
| | | | | Meta |
| . . . | . . . | | | |
| ${T}_{r , f}^{n} \vert \vert 1$ | [symbol] Sig_{I} [symbol] | | | |
| | [symbol] P_{I} [symbol] | | | |

### 7.3 One to Many

FIG. 5 illustrates an example system 500 for facilitating payments between a second party 302 and multiple first parties 301a, 301b, . . . , 301n using an intermediate party 303 (where n can be any number). For convenience, the second party 302 will be referred to as Alice 103a, each first party as an instance of Bob 103b and the intermediate party as Ivan 303. For one-to-many it is assumed that there are multiple Bobs {Bobₖ|k∈[1, m]} and a single Alice. An example of this would be one individual who subscribes to multiple services. Consider an Alice 103a who subscribes to a subscription service such as Netflix, Amazon Prime, Disney+, etc. Rather than personally dealing with the multiple service providers, Alice 103a pays a lump sum to an intermediary, Ivan 303, who then handles the payments to each provider.

Using the PCA technique for said scenario, an intermediary, Ivan 303, is again utilised to manage these payments. This intermediary 303 will accept the lump-sum payment from Alice 103a then establish m payment channels between the set of Bobs.

### The Following Steps are Performed:

Alice 103a discusses with Ivan 303 the criteria for when to submit a settlement transaction (i.e. no longer increase the amount being paid to Bob in a refund transaction).
Alice 103a pays to Ivan 303 a service charge sc+the sum of the different maximums that may be paid per channel.

$$sc + {\sum }_{k = 1}^{m} {Max}_{k}$$

Ivan 303 creates the m payment channels between himself and each Bobₖ. These would each be utilised as a regular payment channel, to facilitate intermittent payments to the corresponding Bobₖ.
Each payment channel is closed after Ivan 303 and the corresponding Bobₖ come to an agreement on the final refund transaction (settlement transaction).

For the payment channel Ivan→Bobₖ an example of the funding transaction

$${T}_{c}^{k}$$

and one of the refund transactions

$${T}_{r , i}^{k}$$

are shown below.

TABLE 11
Funding Transaction. PCA. One-to-Many
${T}_{c}^{k}$

| Version | 1 | | nLockTime | 0 |
|---|---|---|---|---|
| In-count | 1 | | Out-count | 2 |
| Input List | | | Output list | |
| | Unlocking | | | |
| Outpoint | script | Sequence no. | Value | Locking Script |
| Ivan's | [symbol] Sig_{I} [symbol] | 0×ffffffff | Maxₖ BSV | [2-2 multisig Ivan |
| input | [symbol] P_{I} [symbol] | | | Bobₖ] |
| | | | | OP_FALSE |
| | | | | OP_RETURN |
| | | | | Meta |

TABLE 12
Refund Transaction. PCA. One-to-Many
${T}_{r , i}^{k}$

| Version | 1 | | nLockTime | s_{r,k}_{ⱼ} |
|---|---|---|---|---|
| In-count | 1 | | Out-count | 3 |
| Input List | | | Output list | |
| Out- | | Sequence | | |
| point | Unlocking script | no. | Value | Locking Script |
| Tc \|\| 0 | [symbol] Sig_{I} [symbol] [symbol] P_{I} [symbol] | 0×0000000kⱼ | ${Max}_{k} - {x}_{i}^{k}$ | [P2PKH Ivan] |
| | [symbol] Sig_{B}_{ₖ} [symbol] [symbol] P_{B}_{ₖ} [symbol] | | ${x}_{i}^{k}$ | [P2PKH Bobₖ] |
| | | | | OP_FALSE |
| | | | | OP_RETURN |
| | | | | Meta |

Alice 103a would have funded the intermediary Ivan with a regular P2PKH transaction such as shown in Table 13. Note that the service charge sc is included in the funding.

TABLE 13
Transaction to fund all Payment channels for All. PCA. One-to-Many
T_{Funding}

| Version | 1 | | nLockTime | 0 |
|---|---|---|---|---|
| In-count | 1 | | Out-count | 1 |
| Input List | | | Output list | |
| | Unlocking | Sequence | | |
| Outpoint | script | no. | Value | Locking Script |
| | [symbol] Sig_{A} [symbol] [symbol] P_{A} [symbol] | 0×ffffffff | $s c + {\sum }_{k = 1}^{m} {Max}_{k}$ | [P2PKH Ivan] |

### 8. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of facilitating a plurality of respective payments between a plurality of respective first parties and a second party, wherein the method is performed by an intermediate party and comprises:
executing a respective payment channel between each respective first party and the intermediate party, wherein executing the respective payment channel comprises:
   obtaining a respective channel opening transaction, the respective channel opening transaction comprises a respective input signed by the respective first party, and a respective output locked to a respective public key of the respective first party and a public key of the intermediate party, wherein the respective output locks a respective maximum value;
   obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value; and
generating a payment transaction, wherein the payment transaction comprises a plurality of respective inputs, each respective input references a respective second output of a respective final channel closing transaction and comprising a signature of the intermediate party, and an output locked to a public key of the second party, wherein the output locks a value based on a total of the respective second amounts locked by the respective second outputs.

Statement 2. The method of statement 1, wherein the payment transaction comprises metadata relating to one, some or all of the respective payments.

Statement 3. The method of statement 1 or statement 2, wherein for each respective payment channel, the respective first amount of the respective maximum value is equal to the respective maximum value minus a third amount of the respective maximum value, minus a service charge value, and the respective second amount of the respective maximum value is equal to the third amount of the respective maximum value plus the service charge value.

Statement 4. A computer-implemented method of facilitating a plurality of respective payments between a plurality of respective first parties and a second party, wherein the method is performed by an intermediate party and comprises:
obtaining a funding transaction generated by the second party, wherein the funding transaction comprises an input comprising a signature of the second party, and an output locked to a public key of the intermediate party, wherein the output locks an amount at least equal to a total of a plurality of respective maximum values; and
executing a respective payment channel between each respective first party and the intermediate party, wherein executing the respective payment channel comprises:
   obtaining a respective channel opening transaction, the respective channel opening transaction comprises a respective input signed by the intermediate party, and a respective output locked to a respective public key of the respective first party and a public key of the intermediate party, wherein the respective output locks a respective maximum value;
   obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value.

Statement 5. The method of statement 4, wherein the funding transaction comprises metadata relating to one, some or all of the respective payments.

Statement 6. The method of statement 4 or statement 5, wherein the output of the funding transaction locks an amount equal to a total of the respective maximum values plus a service charge.

Statement 7. The method of any preceding, wherein for one, some or all of the respective payment channels, the respective channel opening transaction and/or the respective final channel closing transaction comprises metadata relating to the respective payment.

Statement 8. The method of any preceding statement, wherein the respective output of the respective channel opening transaction and/or the respective output of the respective channel closing transaction comprises a multi-signature locking script.

Statement 9. The method of statement 1 or any statement dependent thereon, wherein the second party provides respective goods and/or respective services to the respective first party in return for the respective payment.

Statement 10. The method of statement 4 or any statement dependent thereon, wherein each respective first parties provide respective goods and/or respective services to the second party in return for the respective payment.

Statement 11. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 10.

Statement 12. A computer program embodied on computer-readable storage and configured so as, when run on one or more processors, to perform the method of any of statements 1 to 10.

According to another aspect disclosed herein, there may be provided a method comprising the actions of the intermediate party and one or both of: i) the plurality of first parties and ii) the second party.

According to another aspect disclosed herein, there may be provided a system comprising the computer equipment of i) the plurality of first parties and ii) the second party.

1. A computer-implemented method of facilitating a plurality of respective payments between a plurality of respective first parties and a second party, wherein the method is performed by an intermediate party and comprises:
executing a respective payment channel between each respective first party and the intermediate party, wherein executing the respective payment channel comprises:
obtaining a respective channel opening transaction, the respective channel opening transaction comprises a respective input signed by the respective first party, and a respective output locked to a respective public key of the respective first party and a public key of the intermediate party, wherein the respective output locks a respective maximum value;
obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value; and
generating a payment transaction, wherein the payment transaction comprises a plurality of respective inputs, each respective input references a respective second output of a respective final channel closing transaction and comprising a signature of the intermediate party, and an output locked to a public key of the second party, wherein the output locks a value based on a total of the respective second amounts locked by the respective second outputs.

2. The method of claim 1, wherein the payment transaction comprises metadata relating to one, some or all of the respective payments.

3. The method of claim 1, wherein for each respective payment channel, the respective first amount of the respective maximum value is equal to the respective maximum value minus a third amount of the respective maximum value, minus a service charge value, and the respective second amount of the respective maximum value is equal to the third amount of the respective maximum value plus the service charge value.

4-6. (canceled)

7. The method of claim 1, wherein for one, some or all of the respective payment channels, the respective channel opening transaction and/or the respective final channel closing transaction comprises metadata relating to the respective payment.

8. The method of claim 1, wherein the respective output of the respective channel opening transaction and/or the respective output of the respective channel closing transaction comprises a multi-signature locking script.

9. The method of claim 1, wherein the second party provides respective goods and/or respective services to the respective first party in return for the respective payment.

10-11. (canceled)

12. A non-transitory computer readable medium comprising a computer program configured so as, when run on one or more processors, the one or more processors perform a method of facilitating a plurality of respective payments between a plurality of respective first parties and a second party, wherein the method is performed by an intermediate party and comprises:
executing a respective payment channel between each respective first party and the intermediate party, wherein executing the respective payment channel comprises:
obtaining a respective channel opening transaction, the respective channel opening transaction comprises a respective input signed by the respective first party, and a respective output locked to a respective public key of the respective first party and a public key of the intermediate party, wherein the respective output locks a respective maximum value;
obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value; and
generating a payment transaction, wherein the payment transaction comprises a plurality of respective inputs, each respective input references a respective second output of a respective final channel closing transaction and comprising a signature of the intermediate party, and an output locked to a public key of the second party, wherein the output locks a value based on a total of the respective second amounts locked by the respective second outputs.

13. A computer-implemented method of facilitating a plurality of respective payments between a plurality of respective first parties and a second party, wherein the method is performed by an intermediate party and comprises:
obtaining a funding transaction generated by the second party, wherein the funding transaction comprises an input comprising a signature of the second party, and an output locked to a public key of the intermediate party, wherein the output locks an amount at least equal to a total of a plurality of respective maximum values; and
executing a respective payment channel between each respective first party and the intermediate party, wherein executing the respective payment channel comprises:
obtaining a respective channel opening transaction, the respective channel opening transaction comprises a respective input signed by the intermediate party, and a respective output locked to a respective public key of the respective first party and a public key of the intermediate party, wherein the respective output locks a respective maximum value;
obtaining one or more respective channel closing transactions including a respective final channel closing transaction, wherein the respective final channel closing transaction comprises a respective input that references the respective output of the respective channel opening transaction and comprises a respective signature of the respective first party and a signature of the intermediate party, and a respective first output locked to a respective public key of the respective first party and a respective second output locked to a public key of the intermediate party, wherein the respective first output locks a respective first amount of the respective maximum value, and wherein the respective second output locks a respective second amount of the respective maximum value.

14. The method of claim 13, wherein the funding transaction comprises metadata relating to one, some or all of the respective payments.

15. The method of claim 13, wherein the output of the funding transaction locks an amount equal to a total of the respective maximum values plus a service charge.

16. The method of claim 13, wherein for one, some or all of the respective payment channels, the respective channel opening transaction and/or the respective final channel closing transaction comprises metadata relating to the respective payment.

17. The method of claim 13, wherein the respective output of the respective channel opening transaction and/or the respective output of the respective channel closing transaction comprises a multi-signature locking script.

18. The method of claim 13, wherein the second party provides respective goods and/or respective services to the respective first party in return for the respective payment.

19. The method of claim 13, wherein each respective first parties provide respective goods and/or respective services to the second party in return for the respective payment.
